(19) United States
(12) Patent Application Publication
(10) Pub. No.: US 2013/0138923 A1
(43) Pub. Date: May 30, 2013

(54) MULTITHREADED DATA MERGING FOR MULTI-CORE PROCESSING UNIT

(71) Applicants: Ronald Jason Barber, San Jose, CA (US); Min-Soo Kim, (US); Jae Gil Lee, Daejeon (KR); Lin Qiao, San Jose, CA (US); Vijayshankar Raman, Santa Clara, CA (US); Richard S. Sidle, Mountain View, CA (US)

(72) Inventors: Ronald Jason Barber, San Jose, CA (US); Min-Soo Kim, (US); Jae Gil Lee, Daejeon (KR); Lin Qiao, San Jose, CA (US); Vijayshankar Raman, Santa Clara, CA (US); Richard S. Sidle, Mountain View, CA (US)

(73) Assignee: INTERNATIONAL BUSINESS MACHINES, Armonk, NY (US)

(21) Appl. No.: 13/307,881

(22) Filed: Nov. 30, 2011

(51) Int. Cl. G06F 9/30

(52) U.S. Cl. 712/203; 712/E09.016

(57) ABSTRACT

Described herein are methods, systems, apparatuses and products for multithreaded data merging for multi-core central and graphical processing units. An aspect provides for executing a plurality of threads on at least one central processing unit comprising a plurality of cores, each thread comprising an input data set (IDS) and being executed on one of the plurality of cores; initializing at least one local data set (LDS) comprising a size and a threshold; inserting IDS data elements into the at least one LDS such that each inserted IDS data element increases the size of the at least one LDS; and merging the at least one LDS into a global data set (GDS) responsive to the size of the at least one LDS being greater than the threshold. Other aspects are disclosed herein.

### BACKGROUND

Micro-architecture design of central processing units (CPUs) and graphical processing units (GPUs) is shifting away from faster single processor systems and towards multiprocessor systems consisting of two or more processors. As a result, the CPUs/GPUs of computer systems are being assembled with multiple cores, each capable of independently executing a thread. For example, CPUs may be comprised of two to sixteen cores on the same die. Software applications configured to process large amounts of data can exploit multi-core CPUs and GPUs in order to achieve accelerated data manipulation.

### BRIEF SUMMARY

In summary, one aspect provides a system comprising: at least one central processing unit comprising a plurality of cores; and a memory device operatively connected to the at least one central processing unit; wherein, responsive to execution of program instructions accessible to the at least one central processing unit, the at least one central processing unit is configured to: execute a plurality of threads, each thread comprising an input data set (IDS) and being executed on one of the plurality of cores; initialize at least one local data set (LDS) comprising a size and a threshold; insert IDS data elements into the at least one LDS such that each inserted IDS data element increases the size of the at least one LDS; and merge the at least one LDS into a global data set (GDS) responsive to the size of the at least one LDS being greater than the threshold.

Another aspect provides a method comprising: executing a plurality of threads on at least one central processing unit comprising a plurality of cores, each thread comprising an input data set (IDS) and being executed on one of the plurality of cores; initializing at least one local data set (LDS) comprising a size and a threshold; inserting IDS data elements into the at least one LDS such that each inserted IDS data element increases the size of the at least one LDS; and merging the at least one LDS into a global data set (GDS) responsive to the size of the at least one LDS being greater than the threshold.

A further aspect provides a computer program product comprising: a computer readable storage medium having computer readable program code configured, the computer readable program code comprising: computer readable program code configured to execute a plurality of threads on at least one central processing unit comprising a plurality of cores, each thread comprising an input data set (IDS) and being executed on one of the plurality of cores; computer readable program code configured to initialize at least one local data set (LDS) comprising a size and a threshold; computer readable program code configured to insert IDS data elements into the at least one LDS such that each inserted IDS data element increases the size of the at least one LDS; and computer readable program code configured to merge the at least one LDS into a global data set (GDS) responsive to the size of the at least one LDS being greater than the threshold.

The foregoing is a summary and thus may contain simplifications, generalizations, and omissions of detail; consequently, those skilled in the art will appreciate that the summary is illustrative only and is not intended to be in any way limiting. For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 provides an example of an MDM_{zero} method.

FIG. 2 provides an example of an MDM_{unlimited} method.

FIG. 3 provides example hardware and software structures associated with certain embodiments.

FIG. 4 provides an example of MDM_{limited} configured according to an embodiment.

FIG. 5 provides an example earlyMerging process according to an embodiment.

FIG. 6 provides an example calcConservativeThreshold process according to an embodiment.

FIG. 7 provides an example calcAggressiveThreshold process according to an embodiment.

FIG. 8 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of certain example embodiments.

Reference throughout this specification to an “embodiment” or “embodiment(s)” means that a particular feature, structure, or characteristic described in connection with the embodiment is included in at least one embodiment. Thus, the appearances of “embodiment” or “embodiment(s)” in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid prolixity.

The central processing units (CPUs) or graphics processing units (GPUs) of modern computer systems designed to handle large amounts of data have multi- or many-core systems, wherein each core is capable of independently executing an active thread. Multi-core systems may have from two to sixteen cores on the same die, while many-core systems may have tens or even hundreds of cores. In addition to the multi- or many-core architectures, CPUs and GPUs may also be configured to support multithreading, such as simultaneous multithreading. For example, Hyper-Threading®(HT) technology allows each core of certain Intel®-based processors to simultaneously run multiple threads. Hyper-Threading® and Intel® are registered trademarks of the Intel Corporation. As such, in an exemplary system with eight processor sockets on the system board, with each processor having eight cores, and the processor supports four threads per core, then, the machine can process up to 256 threads simultaneously.

GPUs may be configured to have a highly parallel structure of many cores (e.g., 512 cores), which can be more effective than general-purpose CPUs for a range of complex applications such as oil exploration, linear algebra, and stock options pricing determinations, which usually require massive vector operations. Software applications designed to handle large amounts of data can exploit multi- and many-core CPUs and GPUs and can accelerate the performance of data manipulation operations. Since each thread can run simultaneously on its corresponding core independently of other threads, the performance of data manipulation may be increased, theoretically, up to the number of threads. In certain applications, such as those requiring massive vector operations, a GPU can yield several orders of magnitude higher performance than a conventional CPU by exploiting its many cores.

Threads may be configured to receive equally divided sets of input data elements, which may be referred to herein as a “partial input data set” (IDS). As a result of manipulating the input data, each thread renders a result in the form of a “global data set” (GDS) before the data is used in a subsequent process, such as the next step of a software program.

One particular process for constructing a GDS using more than one IDS involves each thread directly inserting each IDS element into the GDS data structure one by one. In addition, directly inserting one element may also be regarded as merging more than one IDS into a GDS without using a buffer. This insertion process may be referred to as “multithreaded data merging method with zero-size buffer” (MDM_{zero}). This method has a critical weak point in that system performance may be largely degraded due to a lot of lock overhead and lock contention. The number of lock operations required in MDM_{zero} is the same as the total number of input data elements, which is the sum of numbers of data elements in IDSs. The cost of lock contention is usually very expensive, and moreover, it becomes larger as the number of threads used (N_{threads}) increases.

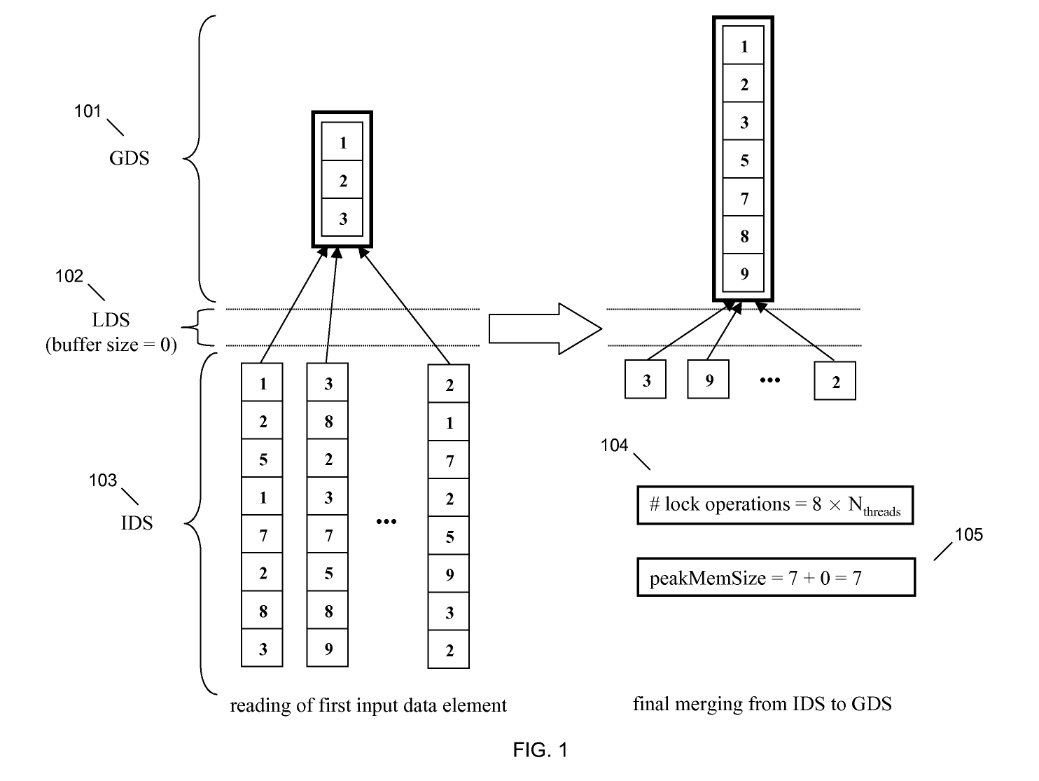

Referring to FIG. 1, therein is provided an example of the MDM_{zero} method with depicting, inter alia, the status after reading an data element from an IDS, and the status after final merging from IDS to GDS. The example of FIG. 1 is comprised of GDS 101, local data set (LDS) 102, and IDS 103 components, and with the number of lock operations 104 consisting of 8 N_{threads}. In FIG. 1, peakMemSize 105 indicates the peak amount of memory used for the data structure containing the GDS 101 and the data structure containing an LDS 102 inside the buffer (not shown). Both GDS 101 and LDS 102 are usually represented in main memory in the form of one or more specific data structures, such as hash, list, tree, or graph data structures. The size of a GDS or LDS may be denoted herein as |GDS| and |LDS|, respectively. In FIG. 1, since there is no LDS, peakMemSize is equal to |GDS|, which, in this particular example, is seven.

In order to avoid performance degradation, many software systems having a shared-nothing architecture (e.g., Hadoop®) use another method, wherein each thread builds its own local data structure from its associated IDS, and then, merges the contents of the local data structure into the global data structure. Hadoop® is a registered trademark of the Apache Software Foundation. Completely building a local data structure may be regarded as using a buffer of unlimited size for merging LDS to GDS. This method may be referred to herein as a “multithreaded data merging method with unlimited-sized buffer” (MDM_{unlimited}). One benefit of the MDM_{unlimited} method is that the performance is much faster than that of MDMₒₙₑ in many cases due to a reduced number of lock operations and function calls.

The core idea of the MDM_{unlimited} method is reducing the number of data elements to be merged to GDS, which require lock contention, as much as possible by getting rid of the redundant data elements existing in each IDS. As such, MDM_{unlimited} may be especially useful when the degree of redundancy among input data elements is high, and at the same time, the intermediate data structure is collapsible. In certain data structures, such as aggregation hash table, the multiple input data elements having the same key value may be stored as one entry when updating the corresponding aggregate field. This type of data structure may be referred to as a “collapsible data structure.” Exemplary collapsible data structures include hash table, B+-tree, trie, and graph data structures.

The MDM_{unlimited} method, however, may be problematic in that peakMemSize can be very large due to many local data structures. In the MDM_{unlimited} method, the multiple data elements having the same key are separately stored in different local data structures if they belong to different IDSs. As such, the sum of |LDS|s may be very large even when |GDS| is small and, as a result, peakMemSize can also be very large.

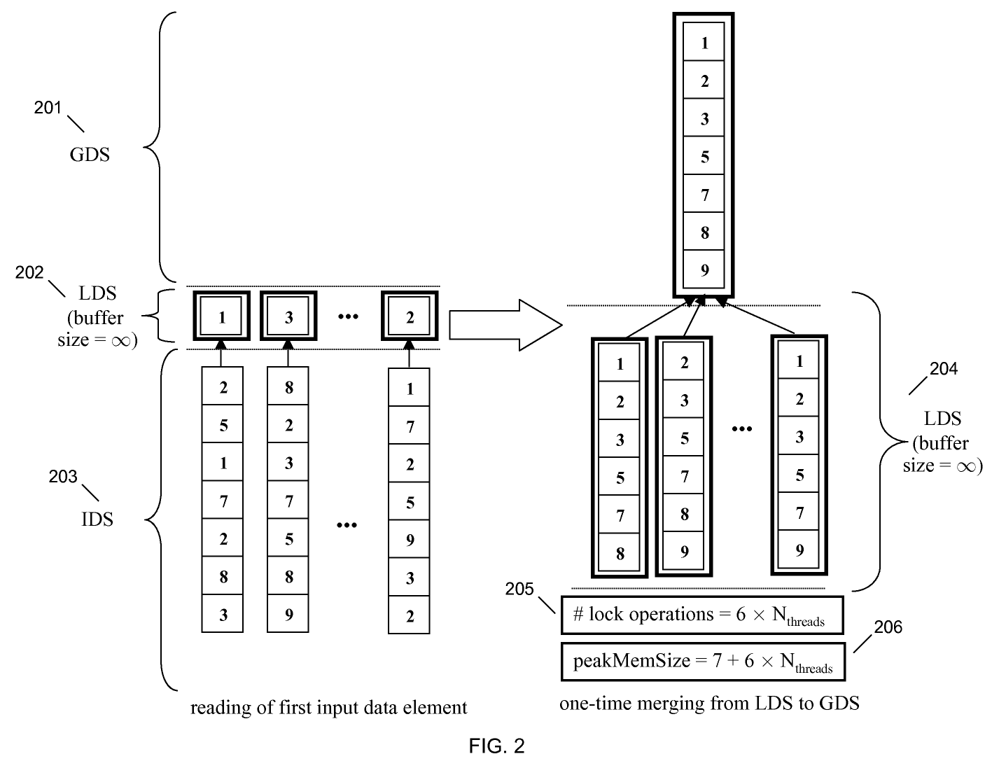

FIG. 2 provides an example of the MDM_{unlimited} method involving reading an input data element and one-time merging from LDS to GDS. The example of FIG. 2 is comprised of a GDS 201, an LDS 202 before merging, an LDS after merging 204, an IDS 203, and a number of lock operations of 6 N_{threads}. As shown in FIG. 2, peakMemSize 206 of MDM_{unlimited} equals 7+6 N_{threads}. In relation to FIG. 1, peakMemSize 105 of MDM_{zero} was only 7. If N_{threads}=16, peakMemSize of MDM_{unlimited} is 7+(6×16)=103, which is 14.7 times larger than that of MDM_{zero} as depicted in FIG. 1.

If the size of one data element in the data structure is larger than the size of a pointer type, peakMemSize 206 of MDM_{unlimited} may be reduced further. MDM_{unlimited} may merge only the pointers to the data elements, instead of the data elements themselves, to the global data structure. In that case, |GDS| of MDM_{unlimited} may be greatly decreased, and may even be decreased as to become negligible. However, peakMemSize 206 may not be reduced much if the sum of |LDS|s takes up most of peakMemSize 206. An example provides that if |GDS| is reduced to 0, peakMemSize 206 of MDM_{unlimited} may be 96, which is still 13.7 times larger than that of MDM_{zero} as depicted in FIG. 1.

Fast data manipulation may be important for mission-critical software systems such as database management systems (DBMS) and data warehouse systems. This presents on particular reason MDM_{unlimited} is preferred over MDMₒₙₑ in many cases, such as for those specific types of systems. However, the large peakMemSize of MDM_{unlimited} could become a fatal problem for the main memory-based database systems, such as C-Store, MonetDB, and SAP database systems, and other software systems that manipulate a large amount of data using main memory. In those cases, the execution of applications could fail, for example, by throwing an exception due to a lack of main memory. This may be especially true when a collapsible data structure is used, and the degree of redundancy among data elements is high.

One particular example involves N_{threads}=16, where each thread builds the aggregation hash table of 2 Gigabytes as the local data structure, wherein a set of hash table entries completely overlap with those of other hash tables due to a high degree of redundancy among input data elements. Then, in this example, peakMemSize of MDM_{unlimited} would be 2 Gigabytes+(2 Gigabytes×16)=34 Gigabytes, while the MDMₒₙₑ method would have a peakMemSize of 2 Gigabytes. If, in this particular example, the amount of available system memory were only 10 Gigabytes, MDM_{unlimited} would fail while MDMₒₙₑ would succeed.

For mission-critical software systems, data manipulation performance may be a function of both efficiency and safety. Current technology produces a problem that involves deciding between fast processing with a large size of memory consumption (e.g., MDM_{unlimited}) and memory efficient processing that sacrifices performance (e.g., MDMₒₙₑ). However, an alternative may involve balancing between performance and memory consumption according to the amount of available memory.

Embodiments provide for data merging that maintains one global data structure and multiple local data structures, each of which uses only a limited amount of memory on each thread. Certain embodiments may be configured to periodically merge LDS to GDS during program execution. Methods, processes, systems, and program products configured according to embodiments disclosed herein may be referred to as an “early merging” method (MDM_{limited}). Merging may be performed according to embodiments whenever the buffer for a particular LDS is full, earlier than merging performed according to existing technology, such as MDM_{unlimited}.

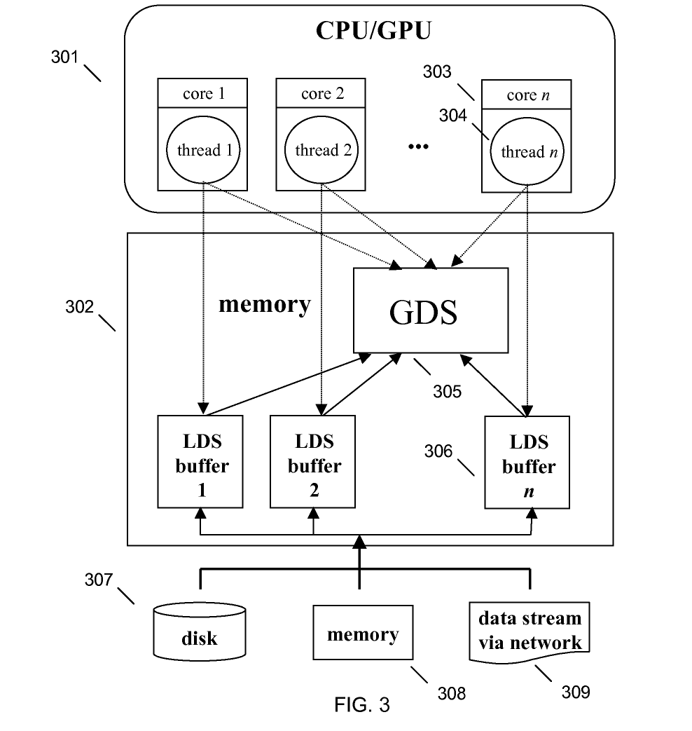

Referring now to FIG. 3, therein is provided example hardware and software structures for operating embodiments disclosed herein. The structures depicted in FIG. 3 may be comprised of CPU/GPU 301 and main memory 302 components. The CPU/GPU 301 component may consist of n cores 303 handling n threads 304. The n threads 304 can read or write both a GDS 305 and n LDS buffers 306 within the main memory 302 component. As shown in FIG. 3, the contents of n LDS buffers 306 are merged into the GDS 305 under the control of the corresponding n threads 304. The main memory 302 component may be operably in communication with one or more system elements, including a disk 307, memory 308, and a data stream 309 handled via one or more networks.

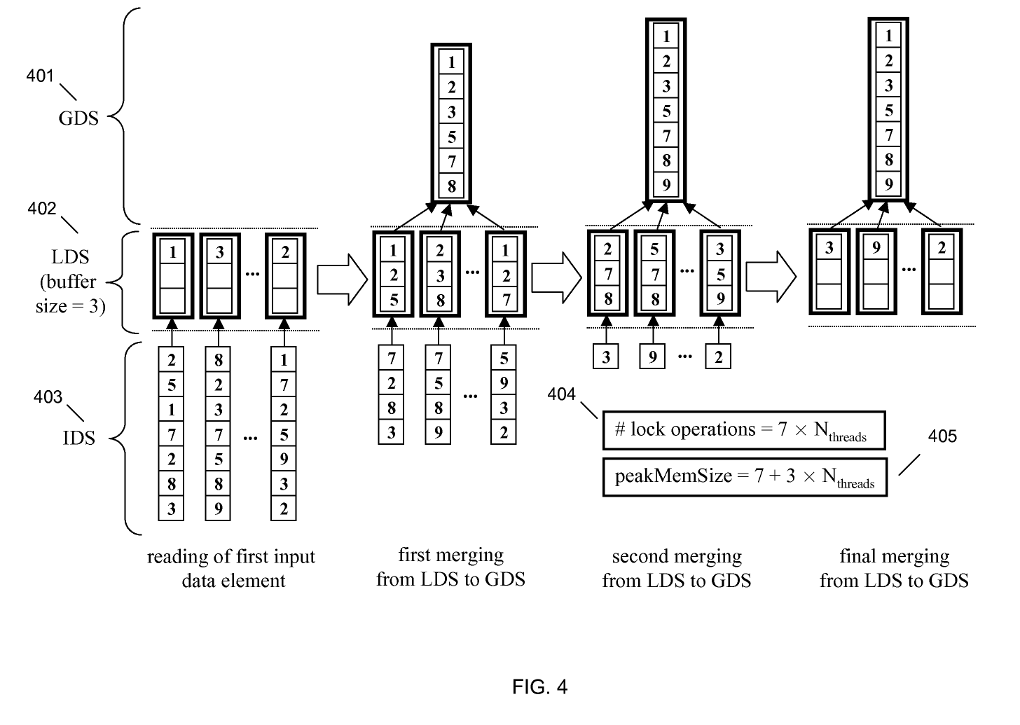

In FIG. 4, therein is provided an example of MDM_{limited} configured according to an embodiment. As shown in FIG. 4, MDM_{limited} may be comprised of GDS 401, LDS 402, and IDS 403 component. In addition, the number of lock operations 404 is set at 7×N_{threads}, which is larger than that of MDM_{unlimited}, and the peakMemSize 405 is 7+3 N_{threads}, which is smaller than that of MDM_{unlimited}. Thus, MDM_{limited} may exhibit less performance, but may be much more memory efficient than MDM_{unlimited}.

According to embodiments, the size of the LDS buffer may be regarded as a threshold trigger for each merging task. As such, the size of buffer may be referred to hereinafter as the “threshold.” Embodiments provide that there may be at least two kinds of threshold, consisting of static and dynamic thresholds. The static threshold makes peakMemSize stable regardless of the input data size, the size of a data element, the degree of redundancy of data elements, or whether or not the type of data structure used is collapsible. As such, peakMemSize may only depend on N_{thread}, where peakMemSize=N_{thread}×|LDS|+|GDS|, and |LDS| is fixed. Thus, the static threshold may be useful in cases where it is hard to predict the input data size, the amount of available memory on the system for data merging task, and the like.

Dynamic threshold configured according to embodiments comprises the dynamic adjustment of the threshold during runtime for a given available system resource. The dynamic threshold may be used to make peakMemSize confined to a fixed amount of available memory on the system. This may have the effect of causing peakMemSize to be strictly stable regardless of associated parameters, and, simultaneously, for making the threshold of each thread realize improved performance. In addition, this process requires that the system provide a process for accessing the available memory size, for example, for data merging tasks on the system. Embodiments provide processes for setting the dynamic threshold, including a “conservative” process and an “aggressive” process, discussed further below.

Certain symbols, such as LDS, GDS, and N_{thread}, have been previously introduced herein. In addition, the following table provides a listing of these and other symbols which will be utilized hereinafter:

TABLE 1
Symbol definitions.

| Symbols | Definitions |
|---|---|
| LDS | Local data set |
| GDS | Global data set |
| \|LDS\| | Average size of local data structure containing a LDS (in bytes) |
| \|GDS\| | Size of global data structure containing the GDS (in bytes) |
| N_{thread} | Number of threads used |
| Nᵢₙₚᵤₜ | Number of input data elements |
| N_{local} | Average number of data elements per LDS (= Nᵢₙₚᵤₜ/N_{thread}) |
| DistinctN_{local} | Average number of distinct data elements per LDS |
| DistinctN_{global} | Number of distinct data elements in the GDS |
| DistinctN_{buffer} | Number of distinct data elements that can be stored in an early |
| | merging buffer (i.e., the size of buffer in terms of the number of |
| | data elements) |
| Redundancy_{local} | Average ratio of redundancy among data elements within a LDS |
| | (= N_{local}/DistinctN_{local}) |
| Redundancy_{global} | Ratio of redundancy among data elements of different LDSs |
| | (= (N_{thread} × N_{local}/Redundancy_{local})/DistinctN_{global})) |
| Redundancy_{buffer} | Average ratio of redundancy among data elements to be inserted |
| | into the early merging buffer |
| Sizeₑₗₑₘₑₙₜ | Size that one data element takes in the data structure (in bytes) |
| Sizeₚₒᵢₙₜₑᵣ | Size of a pointer to a data element (in bytes) |
| NStep_{merging} | Average number of steps to merge LDS to GDS using the early |
| | merging buffer (= N_{local}/(DistinctN_{buffer} × Redundancy_{buffer})) |
| mergeCost_{free} | Time cost when one data element is inserted or merged to LDS |
| mergeCost_{lock} | Time cost when one data element is inserted or merged to GDS |
| | with lock overhead and lock contention |
| copyCostₚₒᵢₙₜₑᵣ | Time cost when the pointer to a data element in a LDS is copied to |
| | the global data structure |
| copyCostₑₗₑₘₑₙₜ | Time cost when a data element itself inside the buffer is copied to |
| | the global data structure |

Values such as peakMemSize and processingTime may be calculated for the MDM_{unlimited} method. For example, embodiments provide that peakMemorySize_{unlimited} may be ascertained according to the following:

$${peakMemorySize}_{unlimited} = {N}_{thread} \times \vert LDS \vert + \vert GDS \vert = {N}_{thread} \times ( {DistinctN}_{local} \times {Size}_{element} ) + {DistinctN}_{global} \times {Size}_{pointer} = {N}_{thread} \times ( {DistinctN}_{local} \times {Size}_{element} ) + ( ( {N}_{thread} \times {DistinctN}_{local} / {Redundancy}_{global} ) \times {Size}_{pointer} ) \qquad ( 1 )$$

If Sizeₚₒᵢₙₜₑᵣ is much smaller than Sizeₑₗₑₘₑₙₜ, the peak memory size may actually depend on N_{local} and DistinctN_{local}. According to embodiments, processingTime_{unlimited} may be calculated as follows:

$${processingTime}_{unlimited} = {buildingTimeOfLDS}_{unlimited} + {mergingTimeToGDS}_{unlimited} = {N}_{local} \times {mergeCost}_{free} + {DistinctN}_{local} \times ( {mergeCost}_{lock} + {copyCost}_{pointer} ) = {N}_{local} \times {mergeCost}_{free} + {N}_{local} / {Redundancy}_{local} \times ( {mergeCost}_{lock} + {copyCost}_{pointer} ) \qquad ( 2 )$$

Threads may operate to build their own data structures during execution. According to embodiments, multiple threads may be assumed to build their own local data structure simultaneously, such that building time for all local data structures is the same with that for one local data structure. Since a thread can insert or merge an input data element to the local data structure without lock overhead and lock contention, mergeCost_{free} may be much smaller than mergeCost_{lock}. The larger N_{thread} becomes, the larger mergeCost_{lock} also becomes since the probability increases that multiple threads compete for updating the same element. As such, if N_{thread} becomes too large, such that N_{local} becomes too small, the overall performance might not be improved even with a smaller N_{local}; rather, performance may be degraded, for example, due to heavy lock contention. In an operating environment where N_{thread} is constant for a given hardware or software setting, processing time may depend mainly on N_{local} and Redundancy_{local}.

The following provides an evaluation for the early merging method MDM_{limited}:

$${peakMemorySize}_{limited} = {N}_{thread} \times \vert LDS \vert + \vert GDS \vert = {N}_{thread} \times ( {DistinctN}_{buffer} \times {Size}_{element} ) + {DistinctN}_{global} \times {Size}_{element} \qquad ( 3 )$$

When comparing MDM_{unlimited} with MDM_{limited}, MDM_{limited} may reduce peakMemSize by N_{thread}×(DistinctN_{local}−DistinctN_{buffer})×Sizeₑₗₑₘₑₙₜ, and at the same time, increases it by DistinctN_{global}×(Sizeₑₗₑₘₑₙₜ−Sizeₚₒᵢₙₜₑᵣ). Since N_{thread}×(DistinctN_{local}−DistinctN_{buffer}) is usually much larger than DistinctN_{global}, especially when the amount of input data is huge and the threshold of the buffer is small, MDM_{limited} may operate to considerably lower peakMemSize.

The following provide formulations for determining values for buildingTimeOfLDS_{limited}, mergingTimeToGDS_{limited}, and processingTime_{limited} according to embodiments:

$$\begin{matrix}{buildingTimeOfLDS}_{limited} = {N}_{local} \times {mergCost}_{free} , where {buildingTimeOfLDS}_{limited} is the same as {buildingTimeOfLDS}_{unlimited} & ( 4 ) \\ {mergeTimeToGDS}_{limited} = {DistinctN}_{buffer} \times {NStep}_{merging} \times ( {mergeCost}_{lock} + {copyCost}_{element} ) = {DistinctN}_{buffer} \times ( {N}_{local} / ( {DistinctN}_{buffer} \times {Redundancy}_{buffer} ) ) \times ( {mergeCost}_{lock} + {copyCost}_{element} ) = {N}_{local} / {Redundancy}_{buffer} \times ( {mergeCost}_{lock} + {copyCost}_{element} ) & ( 5 ) \\ {processingTime}_{limited} = {buildingTimeOfLDS}_{limited} + {mergingTimeToGDS}_{limited} = {N}_{local} \times {mergeCost}_{free} + {N}_{local} / {Redundancy}_{buffer} \times ( {mergeCost}_{lock} + {copyCost}_{element} ) & ( 6 )\end{matrix}$$

In reference to the above formulations, for mergingTimeToGDS_{limited}, the processing time of MDM_{limited} is (Redundancy_{local}/Redundancy_{buffer})×(mergeCost_{lock}+copyCostₑₗₑₘₑₙₜ)/(mergeCost_{lock}+copyCostₚₒᵢₙₜₑᵣ) times slower than MDM_{unlimited}. In addition, Redundancy_{local}>Redundancy_{buffer} since the size of buffer for MDM_{unlimited} is larger than that of MDM_{limited}. Also, (mergeCost_{lock}+copyCostₑₗₑₘₑₙₜ) (mergeCost_{lock}+copyCostₚₒᵢₙₜₑᵣ)≧1. Furthermore, if the size of value is smaller than that of pointer, MDM_{unlimited} may perform merging by using the values instead of the pointers. From the above analysis, how much the performance of MDM_{limited} becomes slow depends on the ratio of Redundancy_{local} to Redundancy_{buffer} and the difference between copyCostₑₗₑₘₑₙₜ and copyCostₚₒᵢₙₜₑᵣ.

According to embodiments, MDM_{limited} may reduce peakMemSize using {N_{thread}×(DistinctN_{local}−DistinctN_{buffer})×Sizeₑₗₑₘₑₙₜ}−DistinctN_{global}×(Sizeₑₗₑₘₑₙₜ−Sizeₚₒᵢₙₜₑᵣ), while scarifying the processing time by (Redundancy_{local}/Redundancy_{buffer})×(mergeCost_{lock}+copyCostₑₗₑₘₑₙₜ)/(mergeCost_{lock}+copyCostₚₒᵢₙₜₑᵣ) times. As such MDM_{limited} configured according to embodiments may operate to mitigate issues associated with current methods, such as MDM_{unlimited}, operating with more memory efficiency.

An exemplary embodiment comprises setting the threshold to the maximum feasible size through availableMemSize( ) for example, to achieve maximum feasible system performance. Further embodiments provide processes for using a static threshold or determining a dynamic threshold value, for example, through conservative and aggressive determination processes. As provided herein, certain processes configured according to embodiments may utilize these threshold values, such as the early merging process, which may be referred to herein as “earlyMerging,” with MDM_{limited}. The following provides an example earlyMerging process according to an embodiment:

| | |
|---|---|
| Input: partial input data set (IDS) | (7) |
| initialize the buffer for LDS | |
| threshold := calcThreshold( ) | |
| for each data element eₓ ε IDS | |
| if there exists the data element e_{y} ε LDS s.t. eₓ = = e_{y} | |
| update e_{y} of LDS | |
| else | |
| if\|eₓ\| + \|LDS\| <= threshold | |
| insert eₓ to LDS | |
| else | |
| merge LDS to GDS | |
| update statistics | |
| threshold := calcThreshold( ) | |
| initialize the buffer for LDS | |
| insert eₓ to LDS | |
| if \|LDS\| ≠ 0 | |
| merge LDS to GDS. | |

In the earlyMerging process provided hereinabove, calcThreshold( ) may be specified as calcStaticThreshold, which returns a fixed threshold, or calcConservativeThreshold or calcAggressiveThreshold, explained further below. According to embodiments, the “update statistics” function within the earlyMerging process may be configured to update the current |GDS| and the total number of data elements merged from all LDSs to GDS. The updated statistics may be available to all threads and may be used in certain processes, such as calcConservativeThreshold and calcAggressiveThreshold.

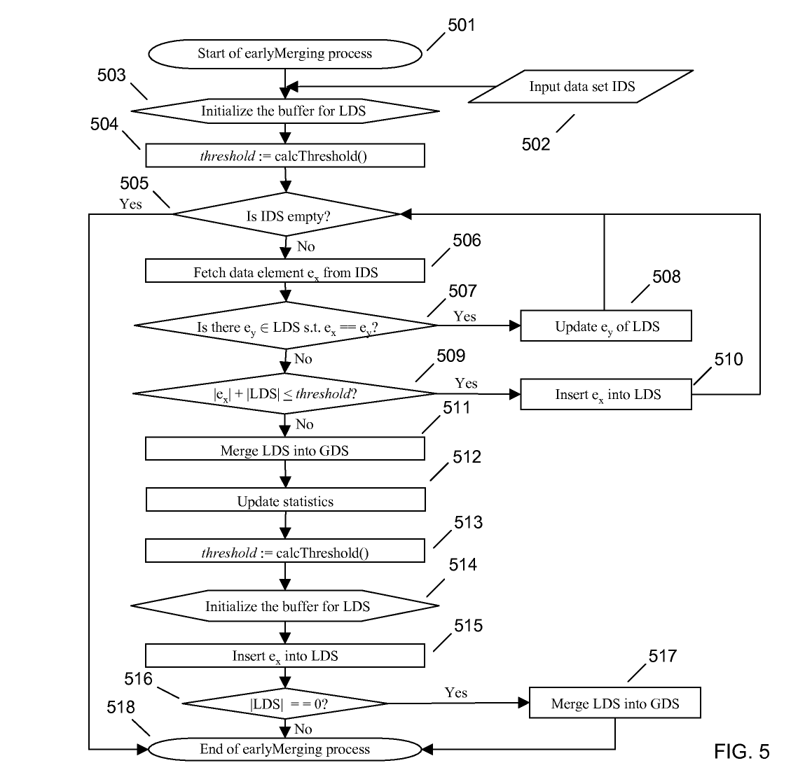

Referring to FIG. 5, therein is provided an example earlyMerging process according to an embodiment. The earlyMerging process is initiated 501 and receives input data set IDS 502. The buffer for LDS is initialized 503 and the threshold is determined according to calcThreshold( ) 504, which, according to embodiments, may be calcStaticThreshold, calcConservativeThreshold, or calcAggressiveThreshold. If the IDS is empty 505, the earlyMerging process is complete 518. If the IDS is not empty 505, then data element eₓ may be fetched from the IDS 506. If there is a data element eₓεLDS such that eₓ==e_{y} 507, then the data element e_{y} is updated 508 and the process again determines whether the IDS is empty 505. If there is not a data element eₓεLDS such that eₓ==e_{y} 507, then the process determines whether |eₓ|+|LDS|≦threshold 509. If |eₓ|+|LDS|≦threshold 509, then data element eₓ is inserted into LDS 510; otherwise LDS is merged into GDS 511. After LDS is merged into GDS 511, the statistics may be updated 512 and the threshold value is calculated using calcThreshold 513. The buffer is initialized for LDS 514 and data element eₓ is inserted into the LDS 515. At this point, the process determines whether |LDS|=0 516; if not, then LDS is merged into GDS, if |LDS|=0 516, then the earlyMerging process is ended.

The following provides a process for calculating a conservative threshold, calcConservativeThreshold, according to an embodiment:

| | |
|---|---|
| Input: currentSize_{GDS}: current \|GDS\| | (8) |
| Output: new threshold | |
| newAvailableMemSize := availableMemSize( ) − currentSize_{GDS} | |
| memForAllLDSs := newAvailableMemSize / 2 | |
| return memForAllLDSs / N_{thread}. | |

Embodiments provide that the calcConservativeThreshold process may be executed every time that a thread finishes merging LDS to GDS. Responsive to the increased current size of |GDS|, the calcConservativeThreshold process may be configured to recalculate the buffer size for one LDS, for example, assuming that the sum of buffer sizes for all LDSs is up to |GDS|. The first call of the calcConservativeThreshold process may return availableMemSize( )/(N_{thread}×2) since currentSize_{GDS}=0.

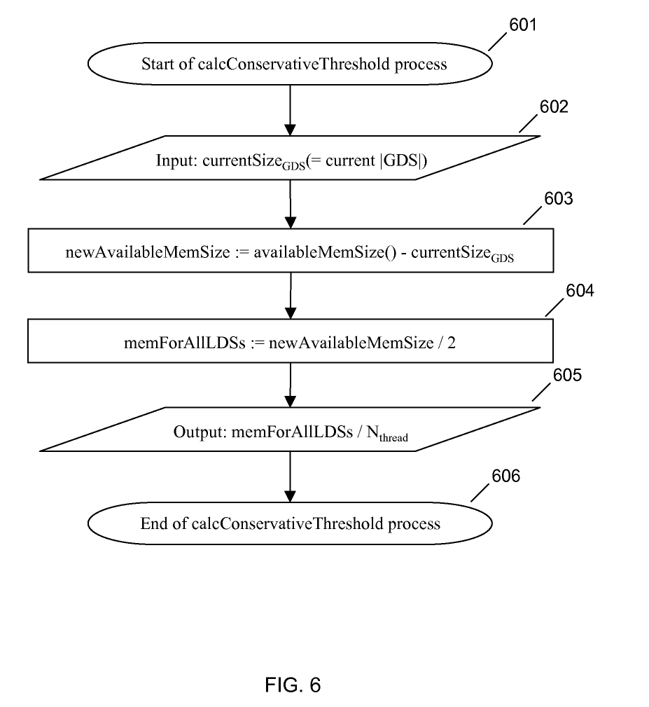

In FIG. 6, therein is provided an example calcConservativeThreshold process according to an embodiment. The calcConservativeThreshold process is initiated 601, receiving currentSize_{GDS} (i.e., the current |GDS|) as input 602. The value of newAvailableMemSize is set to availableMemSize( )−currentSize_{GDS} 603 and the value of memForAllLDSs is set to (newAvailableMemSize/2) 604. The process produces output in the form of memForAllLDSs/N_{thread} 605 and the calcConservativeThreshold process is completed 606.

An aggressive threshold value may also be used in the earlyMerging process. The following provides an example calcAggressiveThreshold process for determining an aggressive threshold according to an embodiment:

| | |
|---|---|
| Input: (1) currentSize_{GDS}: current \|GDS\| | (9) |
| (2) totalNum_{merged}: total number of data elements merged | |
| from all LDSs to GDS so far | |
| Output: new threshold | |
| if totalNum_{merged} = = 0 \|\| currentSize_{GDS} = = 0 | |
| Redundancy_{global} := 1.0 | |
| else | |
| Redundancy_{global} := totalNum_{merged} / currentSize_{GDS} | |
| newAvailableMemSize:= availableMemSize( ) − | |
| currentSize_{GDS} | |
| expectedMemForAllLDSs := newAvailableMemSize × | |
| Redundancy_{global} / (Redundancy_{global} + 1) | |
| return expectedMemForAllLDSs / N_{thread}. | |

The calcAggressiveThreshold process provided hereinabove may operate to recalculate the buffer size for one LDS under certain conditions. A Non-limiting example of such conditions functions under the assumption that the input data elements have a uniform distribution, and Redundancy_{global} of GDS_{after} becomes smaller than Redundancy_{global} of GDS_{before}, where GDS_{after} is the version after one or more LDSs are merged to GDS_{before} (i.e., GDS_{before}⊂GDS_{after}). The first calling of the calcAggressiveThreshold may return availableMemSize( )/(N_{thread}×2), similar to the calcConservativeThreshold process, since Redundancy_{global}=1.0. According to embodiments, the second calling of the calcAggressiveThreshold process may return a larger threshold than the initial threshold, for example, because the threshold has increased, when Redundancy_{global} is larger than 1.0.

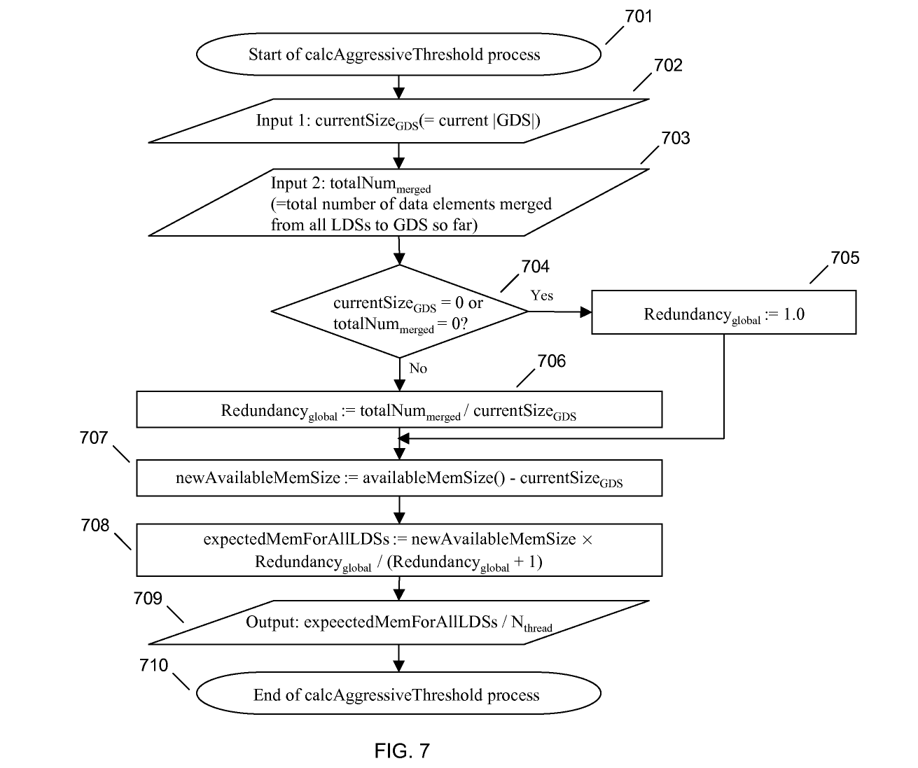

FIG. 7 illustrates an example process for calculating an aggressive threshold using the calcAggressiveThreshold process configured according to an embodiment. The calcAggressiveThreshold process is initiated 701, receiving currentSize_{GDS} (i.e., the current |GDS|) 702 and totalNum_{merged} (i.e., the current total number of data elements that have been merged from all LDSs to GDS) 703 as input. If the CurrentSize_{GDS}=0 or totalNum_{Merged}=0 704, then Redundancy_{global} may be set to 1.0 705; otherwise, Redundancy_{global} may be set to totalNum_{merged} currentSize_{GDS} 706. The process may set the newAvailableMemSize equal to availableMemSize( )−currentSize_{GDS} 707, and may set the expectedMemForAllLDSs equal to newAvailableMemSize×Redundancy_{global}/(Redundancy_{global}+1) 708. The value of expectedMemForAllLDSs/N_{thread} may be returned by the process 709 and the calcAggressiveThreshold process may be complete.

As disclosed herein, embodiments provide processes for early merging, as described in terms of earlyMerging processes and MDM_{limited} configured according to embodiment. In addition, embodiments provide that the earlyMerging processes may be optimized by using a consecutive chunk of memory as a buffer for the local data structure so as to initialize the buffer very fast whenever finishing merging. Another optimization method provided according to embodiments sets the initial size of the local data structure to the size as much as possible within the buffer so as not to need to resize the local data structure during inserting the input data elements to LDS.

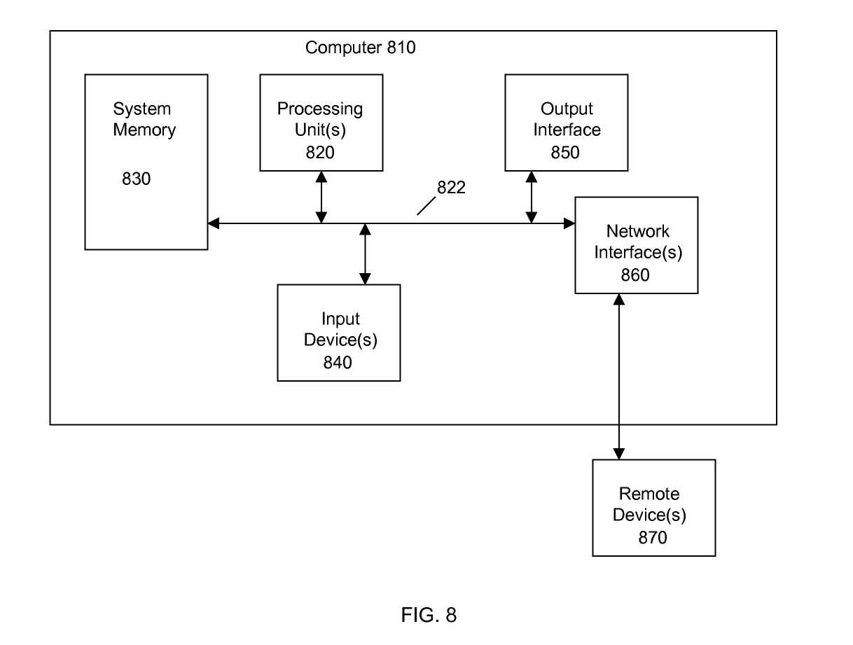

Referring to FIG. 8, it will be readily understood that embodiments may be implemented using any of a wide variety of devices or combinations of devices. An illustrative device that may be used in implementing one or more embodiments includes a computing device in the form of a computer 810 which, for example, may be comprised of certain hardware and software structures provided in FIG. 3 hereinabove.

Components of computer 810 may include, but are not limited to, processing units 820, a system memory 830, and a system bus 822 that couples various system components including the system memory 830 to the processing unit 820. Referring again to FIG. 3, CPU/GPU 301 may be an example processing unit 801 and main memory 302 component may be an example system memory 830 component. Computer 810 may include or have access to a variety of computer readable media. The system memory 830 may include computer readable storage media in the form of volatile and/or nonvolatile memory such as read only memory (ROM) and/or random access memory (RAM), a main memory 302, and additional memory elements 308. In addition, the system memory 830 may be in communication with one or more storage disks 307. By way of example, and not limitation, system memory 830 may also include an operating system, application programs, other program modules, and program data.

A user can interface with (for example, enter commands and information) the computer 810 through input devices 840. A monitor or other type of device can also be connected to the system bus 822 via an interface, such as an output interface 850. In addition to a monitor, computers may also include other peripheral output devices. The computer 810 may operate in a networked or distributed environment using logical connections to one or more other remote computers or databases. In addition, remote devices 870 may communicate with the computer 810 through certain network interfaces 860, for example, to facilitate a data stream 309 handled via one or more networks. The logical connections may include a network, such as a local area network (LAN) or a wide area network (WAN), but may also include other networks/buses.

It should be noted as well that certain embodiments may be implemented as a system, method or computer program product. Accordingly, aspects of the invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” In addition, circuits, modules, and systems may be “adapted” or “configured” to perform a specific set of tasks. Such adaptation or configuration may be purely hardware, through software, or a combination of both. Furthermore, aspects of the invention may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for aspects of the invention may be written in any combination of one or more programming languages, including an object oriented programming language such as Java™, Smalltalk, C++ or the like, conventional procedural programming languages, such as the “C” programming language or similar programming languages, and declarative programming languages such as Prolog and LISP. The program code may execute entirely on the user's computer (device), partly on the user's computer, as a stand-alone software package, partly on the user's computer and partly on one or more remote computers or entirely on the one or more remote computers or on one or more servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
at least one central processing unit comprising a plurality of cores; and
a memory device operatively connected to the at least one central processing unit;
wherein, responsive to execution of program instructions accessible to the at least one central processing unit, the at least one central processing unit is configured to:
execute a plurality of threads, each thread comprising an input data set (IDS) and being executed on one of the plurality of cores;
initialize at least one local data set (LDS) comprising a size and a threshold;
insert IDS data elements into the at least one LDS such that each inserted IDS data element increases the size of the at least one LDS; and
merge the at least one LDS into a global data set (GDS) responsive to the size of the at least one LDS being greater than the threshold.

2. The system according to claim 1, wherein the at least one LDS is stored in at least one local data structure and the GDS is stored in a global data structure.

3. The system according to claim 1, wherein the threshold comprises a static threshold.

4. The system according to claim 3, wherein the static threshold is a fixed value stable throughout runtime.

5. The system according to claim 1, wherein the threshold comprises a conservative threshold.

6. The system according to claim 5, wherein the conservative threshold is equal to an available memory for the at least one LDS divided by a number of threads executing on the at least one central processing unit.

7. The system according to claim 1, wherein the threshold comprises an aggressive threshold.

8. The system according to claim 7, wherein the aggressive threshold is equal to an expected available memory for the at least one LDS divided by a number of threads executing on the at least one central processing unit.

9. The system according to claim 1, wherein the at least one central processing unit is further configured to determine a peak memory size value for indicating a peak amount of memory for the GDS and the at least one LDS.

10. The system according to claim 9, wherein the peak memory size value equals a combined value of a size of the GDS and an average size of the at least one LDS multiplied by the number of threads executing on the at least one central processing unit.

11. A method comprising:
executing a plurality of threads on at least one central processing unit comprising a plurality of cores, each thread comprising an input data set (IDS) and being executed on one of the plurality of cores;
initializing at least one local data set (LDS) comprising a size and a threshold;
inserting IDS data elements into the at least one LDS such that each inserted IDS data element increases the size of the at least one LDS; and
merging the at least one LDS into a global data set (GDS) responsive to the size of the at least one LDS being greater than the threshold.

12. The method according to claim 11, wherein the at least one LDS is stored in at least one local data structure and the GDS is stored in a global data structure.

13. The method according to claim 11, wherein the threshold comprises a static threshold.

14. The method according to claim 13, wherein the static threshold is a fixed value stable throughout runtime.

15. The method according to claim 11, wherein the threshold comprises a conservative threshold.

16. The method according to claim 15, wherein the conservative threshold is equal to an available memory for the at least one LDS divided by a number of threads executing on the at least one central processing unit.

17. The method according to claim 11, wherein the threshold comprises an aggressive threshold.

18. The method according to claim 17, wherein the aggressive threshold is equal to an expected available memory for the at least one LDS divided by a number of threads executing on the at least one central processing unit.

19. The method according to claim 11, wherein the at least one central processing unit is further configured to determine a peak memory size value for indicating a peak amount of memory for the GDS and the at least one LDS.

20. A computer program product comprising:
a computer readable storage medium having computer readable program code configured, the computer readable program code comprising:
computer readable program code configured to execute a plurality of threads on at least one central processing unit comprising a plurality of cores, each thread comprising an input data set (IDS) and being executed on one of the plurality of cores;
computer readable program code configured to initialize at least one local data set (LDS) comprising a size and a threshold;
computer readable program code configured to insert IDS data elements into the at least one LDS such that each inserted IDS data element increases the size of the at least one LDS; and
computer readable program code configured to merge the at least one LDS into a global data set (GDS) responsive to the size of the at least one LDS being greater than the threshold.

21. The computer program product according to claim 20, comprising computer readable program code configured to store the at least one LDS in at least one local data structure and to store the GDS in a global data structure.

22. The computer program product according to claim 20, comprising computer readable program code configured to calculate a threshold comprising a conservative threshold.

23. The computer program product according to claim 22, comprising computer readable program code configured to set the conservative threshold equal to an available memory for the at least one LDS divided by a number of threads executing on the at least one central processing unit.

24. The computer program product according to claim 20, comprising computer readable program code configured to calculate a threshold comprising an aggressive threshold.

25. The computer program product according to claim 24, comprising computer readable program code configured to set the aggressive threshold equal to an expected available memory for the at least one LDS divided by a number of threads executing on the at least one central processing unit.
